(19) United States
(12) Patent Application Publication
(10) Pub. No.: US 2013/0008282 A1
(43) Pub. Date: Jan. 10, 2013

(54) FLOATING FRONT RING

(75) Inventors: Lee Johnson, Absarokee, MT (US); Benjamin Meager, Bozeman, MT (US)

(73) Assignee: PAHA DESIGNS, LLC, Denver, CO (US)

(21) Appl. No.: 13/544,669

(22) Filed: Jul. 9, 2012

Related U.S. Application Data
(60) Provisional application No. 61/505,845, filed on Jul. 8, 2011.

(51) Int. Cl. B62M 9/12; B62M 3/00

(52) U.S. Cl. 74/594.2

(57) ABSTRACT

A bicycle transmission system is provided herein. The bicycle transmission system includes a sprocket or ring that is capable of sliding amongst an infinite number of lateral positions relative to a crank arm. The movement of the sprocket or ring facilitates an optimal chain path from the sprocket or ring to another sprocket or ring in the transmission system and, therefore, increases the efficiency with which power is transferred through the system.

### FIELD OF THE DISCLOSURE

The present disclosure is generally directed toward transmission systems and specifically toward bicycle transmission systems.

### BACKGROUND

Bicycling is becoming an increasingly popular sport. Indeed, bicycles are designed for many purposes from mountain bikes to road bikes, from single speed commuter bikes to ultra light-weight triathlon and time trial bikes, from cruiser bikes to downhill bikes, etc. Many advances in bike technology have come in the form of new materials used for both the frame and components. There has also been a great deal of technological progress in the design of bike components such as brakes, seats, handles, transmission systems, etc.

Transmission systems of most bicycles have multiple speeds that allow the rider to select the appropriate gear ratio to suit the particular riding conditions encountered during a ride. One of the most popular types of gearing assemblies for multi-speed bicycles utilize a chain extending between a set of front chainwheels, which are often referred to as a crankset, and a set of rear gears, which are often referred to as sprockets or a cassette. The crankset is usually equipped to receive pedals and, therefore, are the gears that the rider turns. Power is transferred from the crankset to the cassette via the chain and the cassette is often coupled to a wheel or multiple wheels. Thus, the rotation of the cassette under force of the chain causes the wheel of the bike to spin, thereby propelling the bike along its path.

Multiple derailleurs are often used to switch the sprocket on which the chain is positioned. When a bike transmission system has multiple sprockets (e.g., gears) on both the front crankset and the rear cassette, the bike transmission system is usually equipped with two derailleurs, one for the front gears and one for the back gears.

Other bike transmission systems employ a single front sprocket on the crankset and multiple sprockets on the cassette. In these systems, there is still usually at least one derailleur used to switch the chain from sprocket to sprocket on the rear cassette.

Regardless of whether the transmission system employs a single sprocket or multiple sprockets on the crankset, when the bicycle transmission shifts, the chain connects from the front cassette to the rear cassette at an angle unless the center sprocket(s) are being used. The angled position of the chain between the front crankset and the rear cassette results in two problems.

First, when the chain is angled, the chain joints become misaligned with each other, and therefore, are constantly bent. This adds unnecessary friction to each joint in the chain. Second, the chain is reaching both the front and rear sprockets at an angle. Both of these conditions lead to unnecessary friction on the entire bicycle transmission system. As can be appreciated, this added friction decreases the efficiency of power transmission from the rider to the wheels.

### SUMMARY

It is, therefore, one aspect of the present disclosure to provide a bicycle transmission system that overcomes the above-mentioned shortcomings. Specifically, a floating front ring is proposed herein that provides a smooth and more accurate chain path for bicycle transmission systems. The floating front ring described herein can be incorporated into bicycle transmission systems that employ either a single sprocket or multiple sprockets on the crankset, although it is particularly useful for transmission designs that employ a single sprocket.

In some embodiments, the crankset utilizes a sprocket or set of sprockets that can freely slide horizontally in and out (e.g., substantially perpendicular to the rotational path of the sprocket) to substantially align the chain with the chosen sprocket on the rear cassette. With the chain properly aligned, the efficiency of the transmission system is substantially increased, regardless of the gears chosen by the rider.

Another advantage of the floating front ring described herein is that an aligned chain also helps a bicycle transmission system shift between gears more smoothly as well as maintain its position on the sprocket during use. This occurs because the chain is fed straight from the sprocket on the crankset to the sprocket on the cassette—the angular displacement of the chain is substantially eliminated.

Although embodiments of the present disclosure may be described with reference to a floating front ring on the crankset, it should be appreciated that the relative position of the crankset to the cassette is not limited to a specific position. For example, a bicycle transmission system with a crankset positioned behind the cassette (e.g., as in many adaptive bicycle designs) could also benefit from embodiments of the present disclosure. Further still, the crankset does not necessarily need to be configured to be connected to a pedal and driven by a rider's foot. Rather, the crankset can be configured to be connected to handles or the like. Stated another way, embodiments of the present disclosure can be utilized in any type of transmission system utilizing a chain or similar type of coupling means (e.g., wire, rope, etc.) between a first rotating member and a second rotating member

It is one aspect of the present disclosure to provide a bicycle chain ring that is able to substantially freely slide back and forth (e.g., outwardly toward and inwardly away from a pedal or crank) to maintain a straight line between the chain ring and a desired sprocket on a secondary part of the gear system (e.g., rear gear, cassette, etc.).

It is another aspect of the present disclosure to provide a crank or crankset that supports the chain ring described herein on shafts or similar float elements that allow said chain ring to slide freely in and out, thereby substantially preventing the chain from bending to reach the desired sprocket on the secondary part of the gear system.

It is another aspect of the present disclosure to provide a bicycle crank or crankset that allows the attached sprocket to travel substantially horizontally to prevent the chain from bending when being shifted horizontally by a derailleur.

It is another aspect of the present disclosure to provide a device comprising any of the structural features described herein and shown in the drawings forming part of the disclosure.

In some embodiments a bicycle transmission system is provided that generally comprises:
a crankset including a float element and at least one sprocket configured to rotate in a first rotational direction and further configured to move in a direction substantially perpendicular to the first rotational direction via the float element.

The present invention will be further understood from the drawings and the following detailed description. Although this description sets forth specific details, it is understood that certain embodiments of the invention may be practiced without these specific details. It is also understood that in some instances, well-known circuits, components and techniques have not been shown in detail in order to avoid obscuring the understanding of the invention.

### BRIEF DESCRIPTION OF THE DRAWINGS

The present disclosure is described in conjunction with the appended figures:

FIG. 1 is an isometric view of a crankset in a first configuration in accordance with embodiments of the present disclosure;

FIG. 2 is an isometric view of a crankset in a second configuration in accordance with embodiments of the present disclosure;

FIG. 3 is a top view of the crankset depicted in FIG. 1;

FIG. 4 is a top view of the crankset depicted in FIG. 2;

FIG. 5A is a side view of a crankset in accordance with embodiments of the present disclosure;

FIG. 5B is a cross-sectional and exploded view of the crankset along view line 5-5;

FIG. 6A depicts a bicycle transmission system with a crankset in the first configuration in accordance with embodiments of the present disclosure;

FIG. 6B depicts a bicycle transmission system with a crankset in the second configuration in accordance with embodiments of the present disclosure;

FIG. 7 is a top view of a first alternative crankset design in accordance with embodiments of the present disclosure;

FIG. 8 is a side view of the crankset depicted in FIG. 7;

FIG. 9 is an isometric view of the crankset depicted in FIG. 7;

FIG. 10 is an isometric view of a second alternative crankset design in accordance with embodiments of the present disclosure;

FIG. 11 is an isometric view of a third alternative crankset design in accordance with embodiments of the present disclosure;

FIG. 12 is a top view of the crankset depicted in FIG. 11;

FIG. 13 is a side view of the crankset depicted in FIG. 11;

FIG. 14 is an isometric view of a fourth alternative crankset design in accordance with embodiments of the present disclosure;

FIG. 15 is a top view of the crankset depicted in FIG. 14; and

FIG. 16 is a side view of the crankset depicted in FIG. 14.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

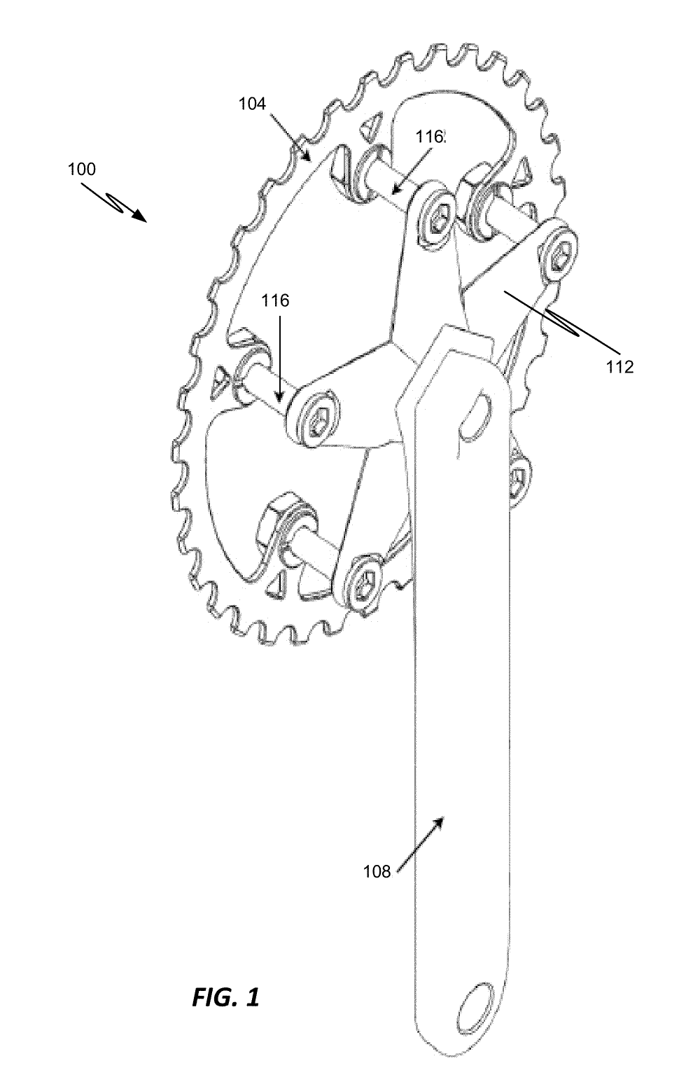

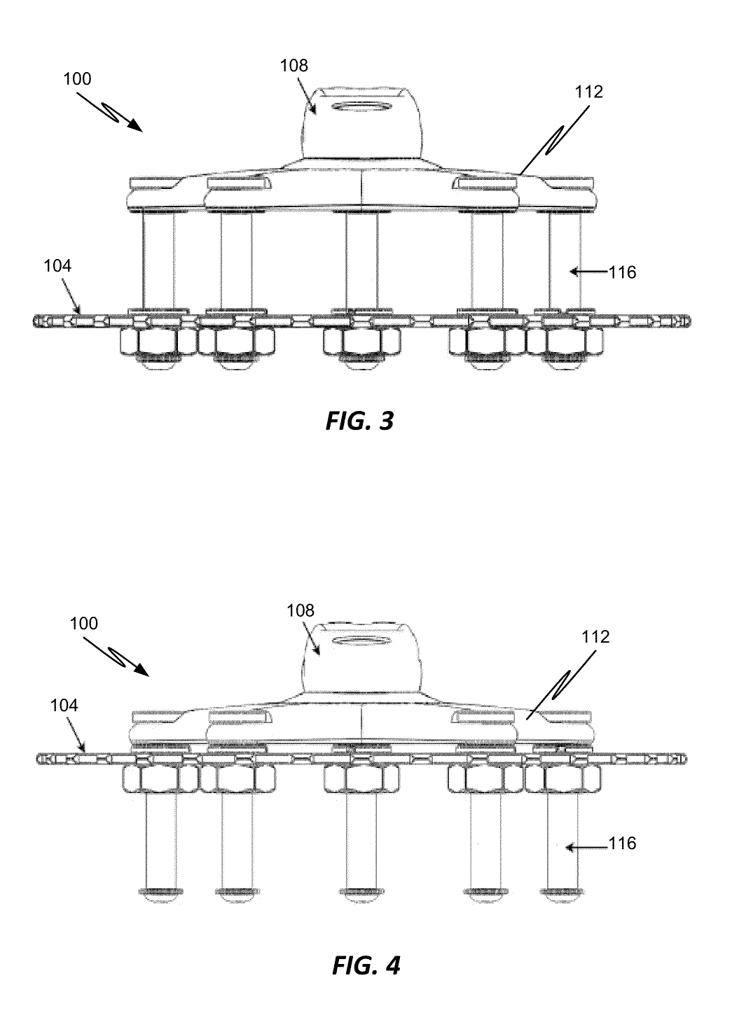

Referring initially to FIGS. 1-6B a first embodiment of a crankset 100 for use in a bicycle transmission system will be described. Features of the crankset 100 described herein can be included in any of the other crankset designs without departing from the scope of the present disclosure. In other words, any feature of any crankset design or configuration described herein may be provided in any other crankset design or configuration.

Furthermore, the crankset components described herein can be manufactured using any type of known manufacturing method. Components of a crankset can be molded, machined, cast, or otherwise produced of any suitable material (e.g., metals, polymers, composites, etc.) and may be connected to one another using any suitable type of mechanical (e.g., fasteners, latches, bolts, screws, friction fittings, snaps, bearings, wheels, rollers, slider mechanism, etc.) or non-mechanical (e.g., glue, adhesives, magnetic, etc.) interface.

FIGS. 1, 3, and 6A show the crankset 100 in a first configuration, namely a configuration where a sprocket or chain ring 104 of the crankset 100 is in a first position on float elements 116 of the crankset 100. Even more specifically, the crankset 100 may comprise a plurality of float elements 116 that enable the sprocket 104 to move laterally with respect to a crank arm 108 of the crankset 100. The first position of the sprocket 104 on the float elements 116 show that the sprocket 104 is completely laterally displaced away from radial extensions 112 of the crankset 100—the sprocket 104 is at a first distance away from the radial extensions 112 of the crankset 100, where the first distance corresponds to a maximum displacement distance.

Traditionally, the radial extensions 112 of a crankset are fixedly secured to the sprocket 104 or set of sprockets and, therefore, do not allow the sprocket or set of sprockets to move relative thereto. Embodiments of the present disclosure, however, provide a plurality of float elements 116 that are attached to the radial ends of the radial extensions 112. Although five float elements 116 are depicted in the embodiments of FIGS. 1-6B, it should be appreciated that a greater or lesser number of float elements 116 may be employed without departing from the scope of the present disclosure. Furthermore, the number of float elements 116 does not necessarily have to equal the number of arms of radial extensions 112 that connect to the crank arm 108.

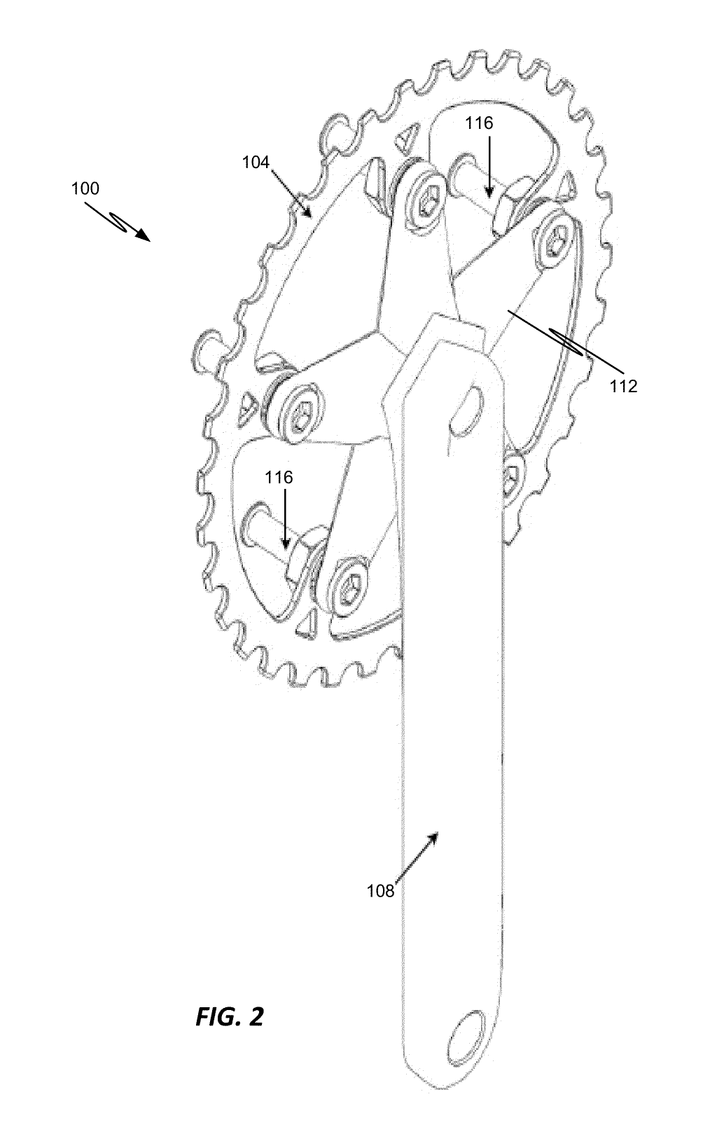

FIGS. 2, 4, and 6B show the crankset 100 in a second configuration, namely a configuration where sprocket 104 of the crankset 100 is in a second position on float elements 116. The second position of the sprocket 104 on the float elements 116 show that the sprocket 104 is completely laterally displaced toward or adjacent to radial extensions 112—the sprocket 104 is at a second distance away from the radial extensions 112 of the crankset 100, where the second distance corresponds to a minimum displacement distance.

In some embodiments, the length or size of the float elements 116 dictates the distance between the first position and the second position. The float elements 116 may be sized to correspond to a size of a cassette 604 that will be employed as part of the bicycle transmission system. It may be desirable to have the length of float elements 116 be as short as possible (e.g., to minimize stresses induced on float elements 116), but not so short that a chain 608 extending from the sprocket 104 to a sprocket on the cassette 604 has to extend at an angle. Rather, it may be preferable to size the float elements 116 to have a length that causes the sprocket 104, when positioned in the first position, to be substantially aligned with a first endmost sprocket on cassette 604 and, when positioned in the second position, to be substantially aligned with the opposite endmost sprocket on cassette 604.

Advantageously, the float elements 116 are constructed to enable the sprocket 104 to slide or float freely between the first position (e.g., maximum displacement) and the second position (e.g., minimum displacement). In other words, a smooth or substantially obstruction-free interface between the sprocket 104 and the float elements 116 enables the sprocket 104 to move to any non-incremental position between the first position and the second position. This advantageously allows the crankset 100 to be used with cassettes 604 of varied sizes.

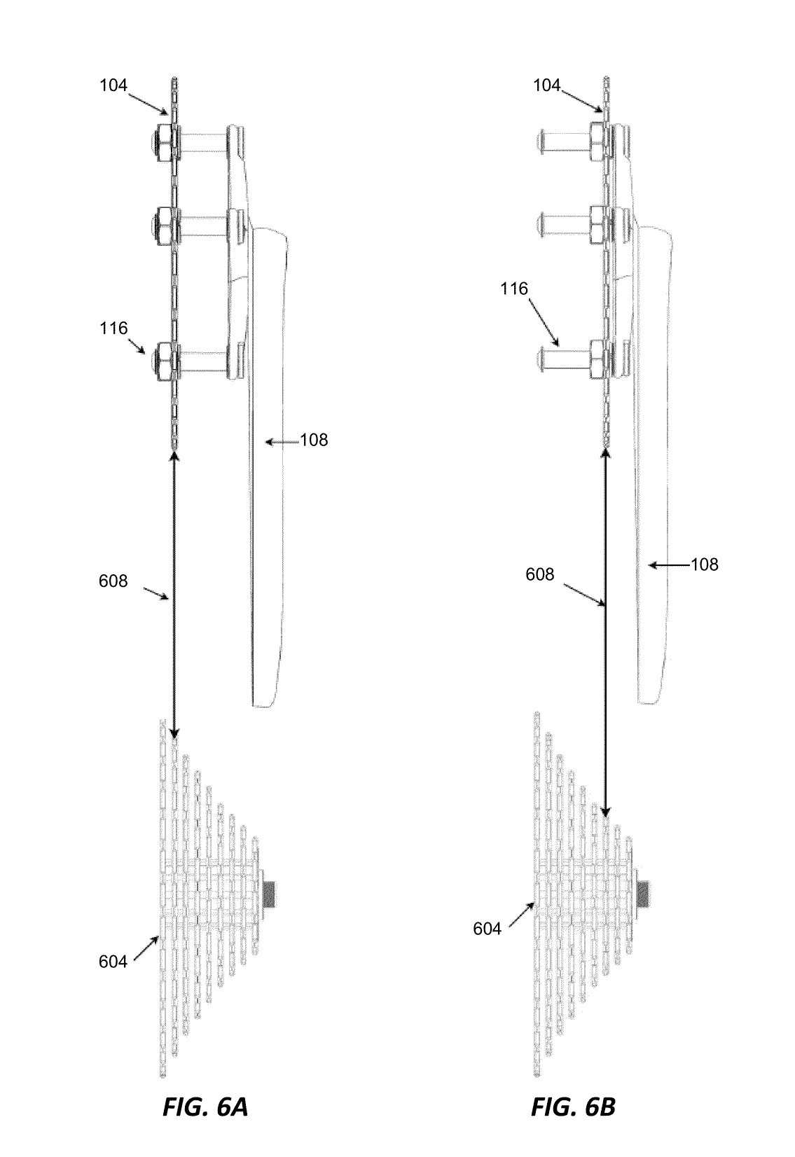

As can be seen in FIGS. 6A and 6B, because the sprocket 104 is allowed to move along float elements 116 between its first position and second position substantially unobstructed, the chain path between the sprocket 104 of the crankset 100 and the selected sprocket of the cassette is always substantially linear. In other words, the chain 608 will almost always be positioned directly over the teeth of both sets of sprockets and will, therefore, not be creating any unnecessary friction at its chain joints or at the sprocket teeth. This means that rotational forces of the sprocket 104 will be transferred to the cassette 604 with fewer frictional losses as compared to bicycle transmission systems of the prior art.

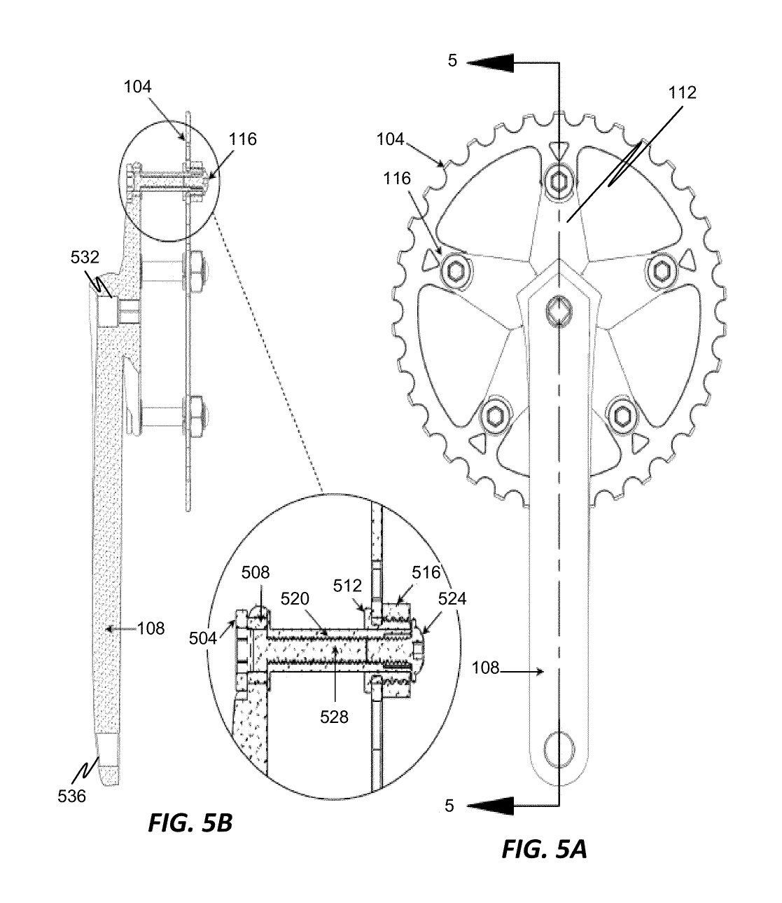

With reference now to FIGS. 5A and 5B, additional details regarding the construction of the crankset 100 will be described in accordance with embodiments of the present disclosure. As described above, the crank arm 108 may be attached to one or more radial elements 112. Each of the radial elements 112 may connect or otherwise interface with the crank arm 108 at a common point (e.g., a proximate end). The proximate end of the crank arm 108 at which the radial elements 112 connect may also coincide with a rotation point of the crankset 100. Specifically, a crankset 100 may comprise a hub or bearing portion about which the entire crank arm 108 and sprocket(s) 104 rotate. The hub or bearing portion may comprise a bore 532 or the like that enables a pin or shaft extending from an opposite crank arm and through the frame of the bicycle to interconnect with the bore 532 of the crankset 100. The hub portion may correspond to a common point about which the radial elements 112 are centered.

The opposite end of the crank arm 108 (e.g., the distal end) may be configured to receive a pedal or a similar type of human interface. The distal end may also comprise a bore 532 that receive a pedal or the like.

As can be seen in FIG. 5A, the radial elements 112 may be integrated with the crank arm 108. In other words, the radial elements 112 and crank arm 108 may be formed as a single unitary piece of material (e.g., metal or composite). The radial elements 112 and crank arm 108 may be formed using any suitable manufacturing process such as, for example, casting, molding, machining, milling, use of any other machine whose toolpaths can be controlled via computer numerical control, or the like.

In some embodiments, the radial elements 112 may comprise an outward facing surface (e.g., a surface that faces away from the sprocket 104) and an inward facing surface (e.g., a surface that faces toward the sprocket 104). The inward facing surface may be substantially flat or planar thereby enabling the sprocket 104 to rest adjacent thereto when the sprocket 104 is in the second position (e.g., a minimum displacement position). Of course, the radial elements 112 may be provided with one or more spacer mechanisms (e.g., plastic washers) that inhibit the sprocket 104 from resting immediately adjacent thereto.

The exploded view of the float element 116 in FIG. 5B shows one way in which the sprocket 104 can be adapted to float or move freely between its first position and second position. While some aspects of the float element 116 are depicted as being separate pieces from the sprocket 104 and/or radial element 112, it should be appreciated that one or more pieces of the float element 116 may be integrated into or combined with either the radial element 112 or the sprocket 104. For instance, certain pieces of the float element 116 that are depicted as interfacing with the radial element 112 may be constructed as part of the radial element 112 rather than part of the float element 116. Likewise, certain pieces of the float element 116 that are depicted as interfacing with the sprocket 104 may be constructed as part of the sprocket 104 rather than part of the float element 116.

Some of the piece parts that may be included in float element 116 include, without limitation, an attachment end 504, an attachment main body 508, a slider bracket 512, a slider nut 516, a hollow shaft 520, a stopper 524, and a threaded inner surface 528. The attachment main body 508 may be attached to the distal end of the radial element 112 via the attachment end 504. As can be seen in FIG. 5B, the attachment end 504 may comprise a flanged portion having a radius that is larger than a radius of a bore extending through the distal end of the radial element 112. The attachment end 504 substantially inhibits the float element 116 from being pulled through the bore of the radial element 112. In some embodiments, the attachment end 504 and attachment main body 508 may be integrated into the radial element 112 (e.g., cast as part of the radial element 112) or it may be a separate piece that is attached to the radial element 112 via one or more of welding, snapping, screwing, gluing, fastening, etc. In some embodiments, the attachment end 504 may be separately screwed into or otherwise receive the hollow shaft 520 by extending through the attachment main body 508. Any type of mechanical interface between the hollow shaft 520 and radial element 112 can be used, meaning that the attachment end 504 and attachment main body 508 may be provided in a variety of different configurations.

The depicted hollow shaft 520 comprises a generally cylindrical and smooth outer surface and a threaded inner surface 528. The threaded inner surface 528 may comprise threading throughout the length of the hollow shaft 520 (e.g., the length of the float element 116) or it may comprise a partially threaded inner surface that is only threaded near the ends of the hollow shaft 520. The threaded inner surface 528 may correspond to a female portion of an interface at both ends that, on one end, is adapted to receive a threaded male portion from the attachment main body 508 and, at the other end, is adapted to receive a threaded male portion from the stopper 524. It should be appreciated, however, that the shaft 520 may not necessarily be hollow and it may comprise male threaded portions at one or both of its ends and the corresponding other parts of the float element 116 (e.g., attachment main body 508 and stopper 524) may be equipped with female threaded portions. Moreover, non-threaded interfaces such as snap fits, welded joints, glued portions, or the like may be used to connect the various parts of the float element 116. Further still, as noted above, the attachment end 504, attachment main body 508, hollow shaft 520, and stopper 524 may be a single unitary piece of material.

The outer surface of the shaft 520 may be configured to allow the slider nut 516 and slider bracket 512 to slide substantially unobstructed across the length of the shaft 520. In the depicted embodiment, the slider bracket 512 comprises an inner radius that is sized to receive and fit around the outer surface of the shaft 520. The slider bracket 512 and slider nut 516 may be configured to connect through a bore in the sprocket 104 and, therefore, mechanically secure the sprocket 104 to the float element 116. Furthermore, the slider bracket 512 and slider nut 516 may enable the sprocket 104 to slide or float along the length of the shaft 520 anywhere between the stopper 524 and flat main surface of the radial element 112. In particular, any lateral forces (e.g., forces that are parallel to the length of the shaft 520) exerted on the sprocket 104 by the chain 608 may cause the slider bracket 512 to move along the shaft 520 until the lateral forces are no longer present or minimized.

Although the shaft 520 is depicted in FIG. 5B as having a smooth outer cylindrical surface, it should be appreciated that other non-cylindrical shapes could be employed or one or more longitudinal features may be provided along the length of the shaft 520 to help guide the slider bracket 512 along the length of the shaft 520. For instance, the shaft 520 may comprise one or more ribs (e.g., raised surfaces) or one or more notches (e.g., depressed surfaces) that are substantially continuous along the length of the shaft 520 extending from the attachment main body 508 to the stopper 524. The inner surface of the slider bracket 512 may have one or more complimentary features if the outer surface of the shaft 520 is provided with one or more features.

In other words, if the outer surface of the shaft 520 is substantially smooth and cylindrical, then the inner surface of the slider bracket 512 may also be substantially smooth and cylindrical. If the outer surface of the shaft 520 has one or more features (e.g., raised, depressed, etc.) or is not of a substantially cylindrical shape (e.g., has a polygonal cross-sectional shape, an oblong shaped, an elliptical shape, etc.), then the inner surface of the slider bracket 512 may also have one or more complimentary features to match the outer surface of the shaft 520.

The slider bracket 512 is depicted as having a main flange part that connects to an extended threaded section (e.g., a male threaded section). The threaded section may extend through the bore of the sprocket 104 and the slider nut 516 may have a corresponding threaded section (e.g., a female threaded section) to interface with the threaded section of the slider bracket 512. The slider nut 516 may tighten down around the slider bracket 512 and hold the slider bracket 512 securely to the sprocket 504.

The materials used for the shaft 520 and the slider bracket 512 as well as any other portion that interfaces therewith should be chosen to have a minimal static and dynamic coefficient of friction. As some non-limiting examples, one or more of the following materials or combinations of materials could be used for the shaft 520 and/or slider bracket 512: metal-on-metal interface (e.g., metal slider bracket 512 and metal shaft 520), metal-on-polymer interfaces (e.g., metal slider bracket 512 and polymer shaft 520 or vice versa), polymer-on-polymer interfaces (e.g., plastic slider bracket 512 and plastic shaft 520), etc. In more specific embodiments, the materials may be chosen so as to maintain the static coefficient of friction between the shaft 520 and slider bracket 512 to be about or less than 0.2 (e.g., for Polyethene on steel interfaces). In a more preferred embodiment, the materials may be chosen so as to maintain the static coefficient of friction between the shaft 520 and slider brackets 512 to be about or less than 0.04 (e.g., for steel on Polytetrafluoroethylene (PTFE) or any other type of synthetic fluoropolymer or highly-ordered polymer or highly-ordered pyrolytic). In some embodiments, the materials for the shaft 520 and slider bracket 512 may be selected from one or more of the following: steel, aluminum, copper, brass, ceramic, graphite, PTFE, nylon, High Density Polyethylene (HDPE), composites, wood, etc.

It may also be possible to decrease the friction between the shaft 520 and slider bracket 512 by using either friction-reducing devices or lubricants. As one example, the slider bracket 512 may be equipped with a plurality of internal ball bearings that are made of any suitable material and enable the slider bracket 512 to move freely across the shaft 520. As another example, the interface between the slider bracket 512 and shaft 520 may be treated with one or more surface lubricants (e.g., graphite or talc) that help reduce the coefficient of friction between the two components.

As can be seen in FIG. 5B, the slider nut 516 may be provided to face the outer end of the float element 116. However, it should be appreciated that the slider nut 516 can be provided on the inward facing side of the slider nut 516 such that it contacts the radial element 112 when the sprocket 104 is in a minimum displacement position and the flange portion of the slider bracket 512 may contact the stopper 524 when the sprocket 104 is in a maximum displacement position.

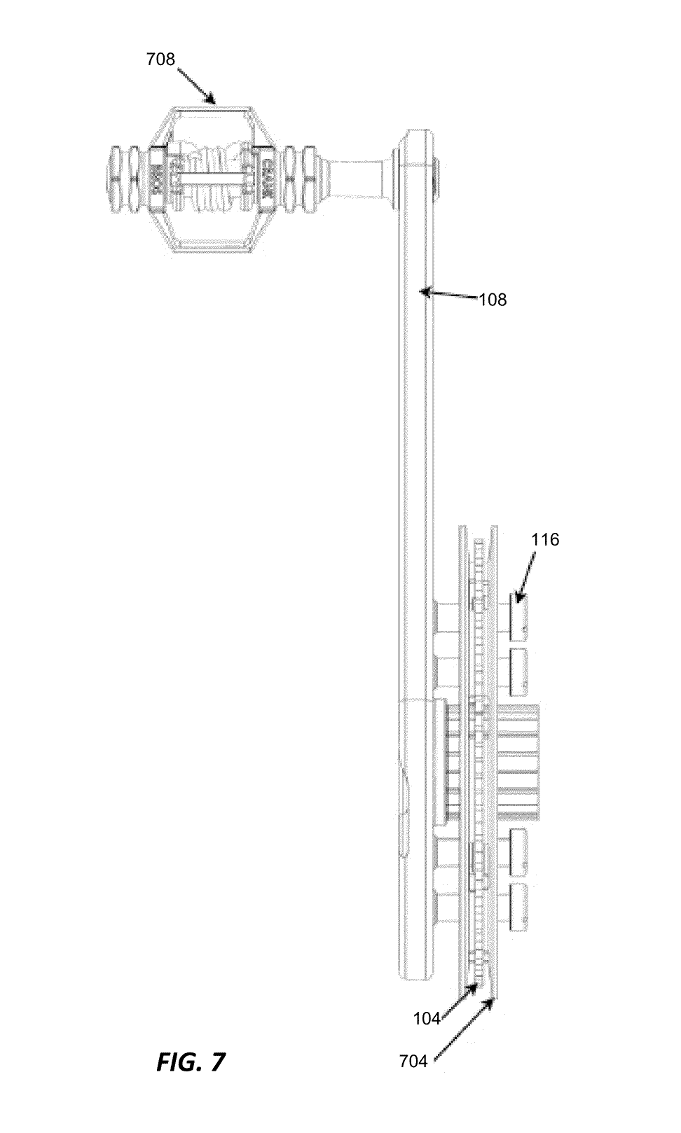

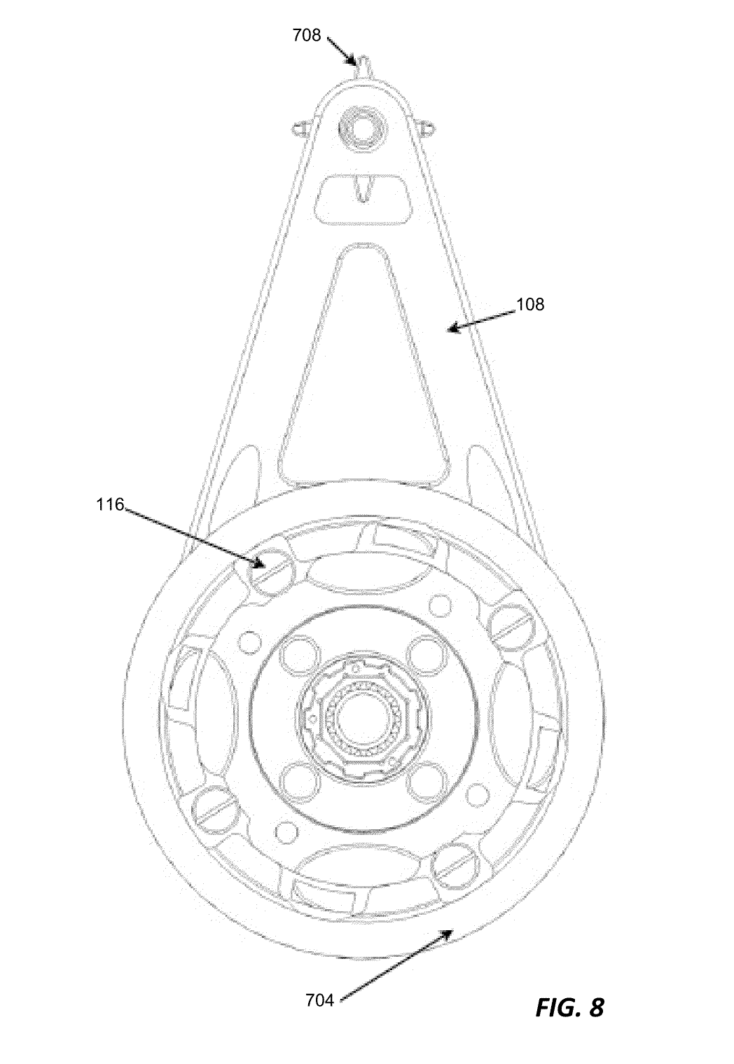

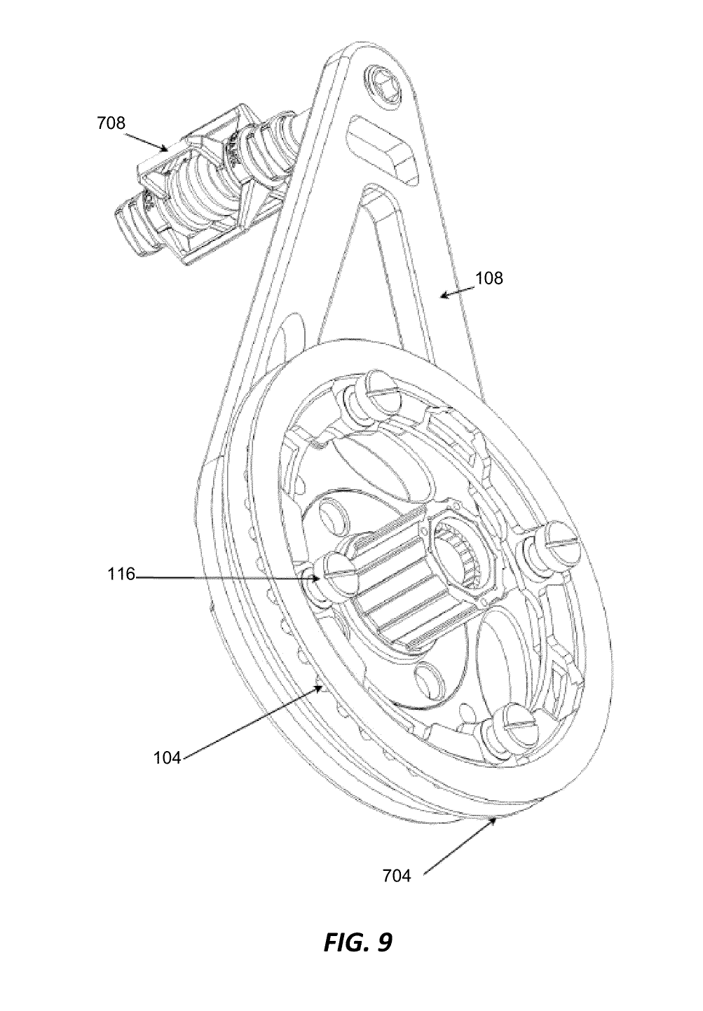

The embodiments of FIGS. 1-6B show the crankset 100 as comprising five radial elements 112 and five float elements 116. It should be appreciated that embodiments of the present disclosure are not so limited. For example, FIGS. 7-10 depict cranksets with different numbers of float elements 116. FIGS. 7-9, for instance, depict a crankset 100 with four float elements 116.

Another feature of the crankset 100 in FIGS. 7-9 is the utilization of a different type of crank arm 108 configuration. Specifically, the crank arm 108 is depicted as having two arms that extend from its distal end (e.g., the end which connects with the pedal 708) in a generally triangular shape. The crank arm 108 is also planar on both its inward and outward facing surfaces and the float elements 116 are integrated into the crank arm 108. More specifically, the crank arm 108 and float elements 116 are provided as a single unitary piece and there is no need for threaded sections, screws, or nuts for creating the float element 116 or for interfacing the float element 116 with the crank arm 108.

Yet another feature of the crankset 100 in FIGS. 7-9 is the integration of the slider bracket 512 and slider nut 516 into the sprocket 104. More specifically, the sprocket 104 is depicted as having a chain guard 704 surrounding and protecting the sprocket 104 in a known fashion. The sprocket 104 also has bores provided therein which are fit to receive and move laterally along the float elements 116.

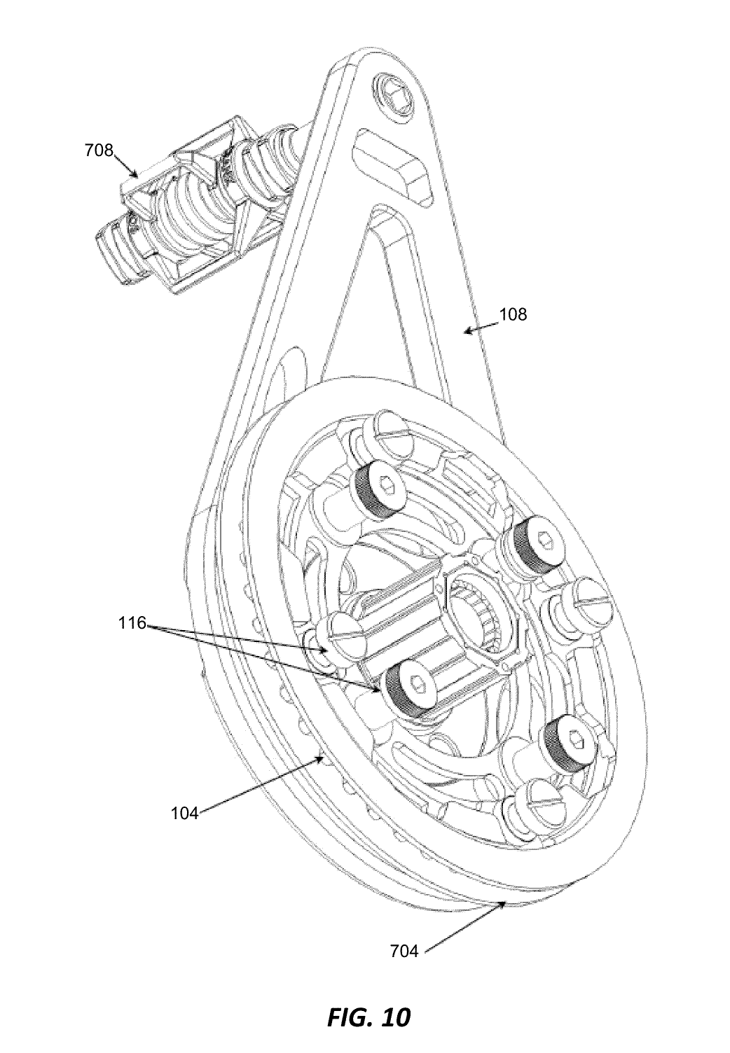

FIG. 10 shows how additional float elements 116 can be provided along different parts of the sprocket 104. In particular, the crankset 100 of FIG. 10 boasts eight float elements 116. Some or all of the float elements 116 may be integrated into the crank arm 108. On the other hand, some of all of the float elements 116 may be similar to the float elements 116 of FIGS. 1-6B and are configured to attach to the crank arm 108. Further still, some of the float elements 116 may be integral to the crank arm 108 and some of the float elements 116 may be separately constructed components. It should also be noted that some of the float elements 116 are provided at one distance from the hub of the sprocket 104 (e.g., a first radium away from the center of rotation) and others of the float elements 116 are provided at a different distance from the hub of the sprocket 104.

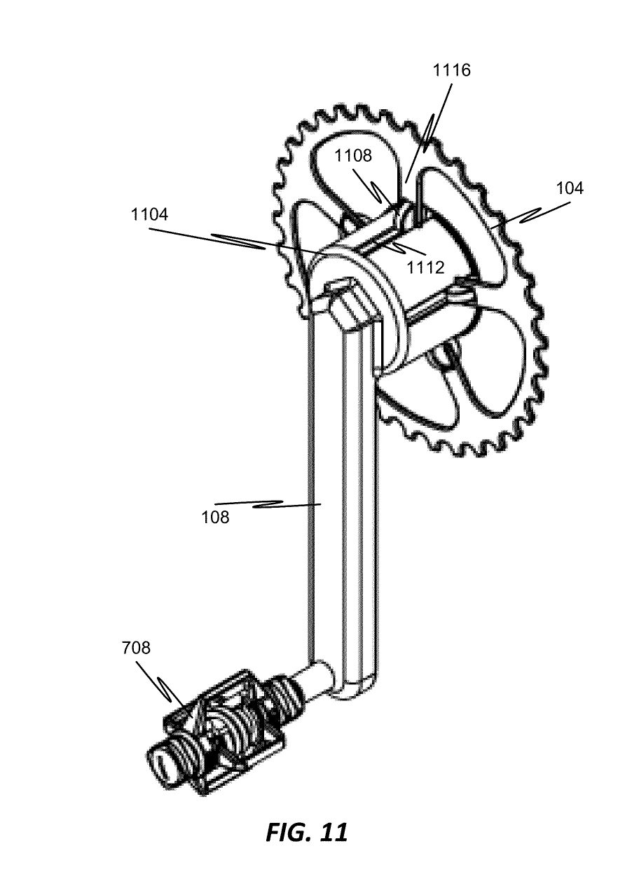

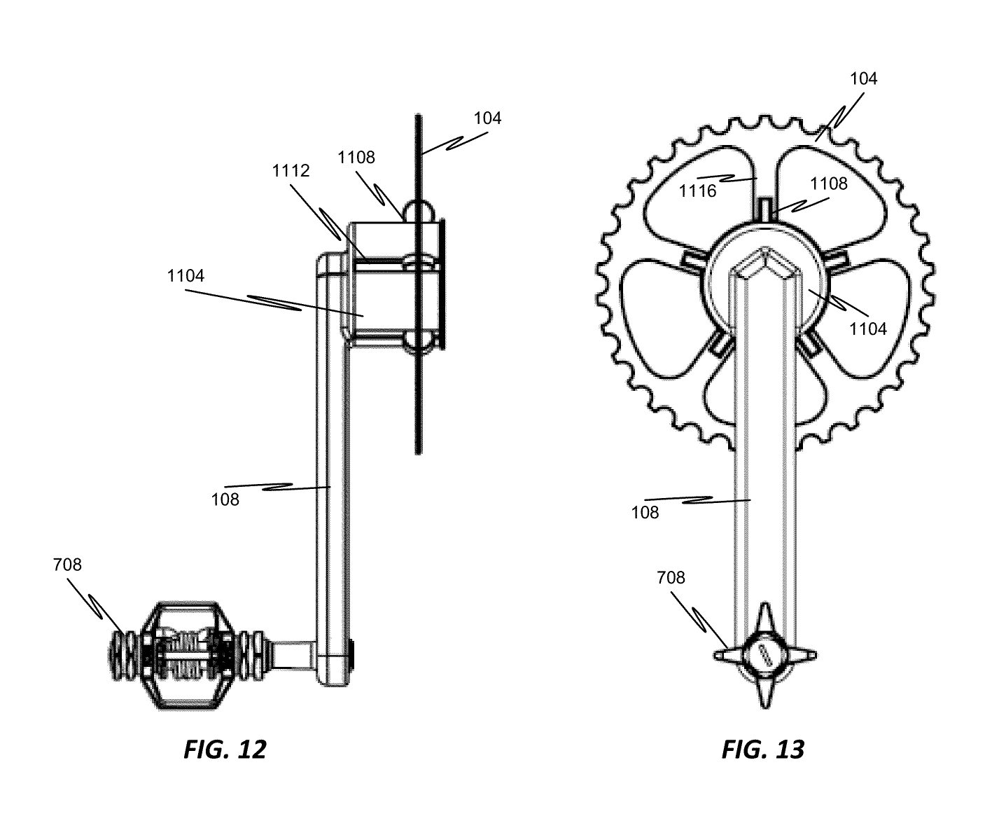

FIGS. 11-13 depict yet another crankset 100 design where different types of float elements are employed. In particular, rather than employing float elements 116 that rely on a shaft design and the utilization of a sliding action, the crankset 100 of FIGS. 11-13 employ a specially configured main body 1104. The main body 1104 of the crankset 100 comprises one or more slots, tracks, or rails 1112 that interface with one or more wheels 1108. The wheels 1108 may be connected to the sprocket 104 via an axel or pin-type configuration. In particular, radial elements 1116 may be provided on the sprocket 104 and each radial element 1116 may comprise a notch to receive the wheels 1108 and a pin or axel on which the wheels 1108 are allowed to rotate. The wheels 1108 then fit on or into the tracks 1112. As lateral forces are exerted on the sprocket 104 by the chain 608, the sprocket 104 is free to move along the length of the main body 1104 due to the interface between the wheels 1108 and tracks 1112.

In some embodiments, the tracks 1112 may be provided as minor depressions or recesses in the main body 1104. The wheels 1108 may fit into the tracks 1112 and be free to roll or move within the tracks 1112.

The main body 1104 may be a solid piece of material or it may be hollow. In some embodiments, the main body 1104 is a hollow piece of material (e.g., metal, composite, carbon fiber, polymer, etc.) with a cylindrical outer surface. The cylindrical outer surface may comprise a number of recesses extending laterally along the length of the cylinder to establish the tracks 1112. The depth of the tracks 1112 does not have to be extraordinarily deep, but should be sized to ensure that the wheels 1108 stay in the tracks 1112 while also allowing the sprocket 104 to move freely along the length of the main body 1104. The tracks 1112 may end as the proximal and distal ends of the main body 1104 and these track ends may correspond to the limits of the sprocket's 104 movement.

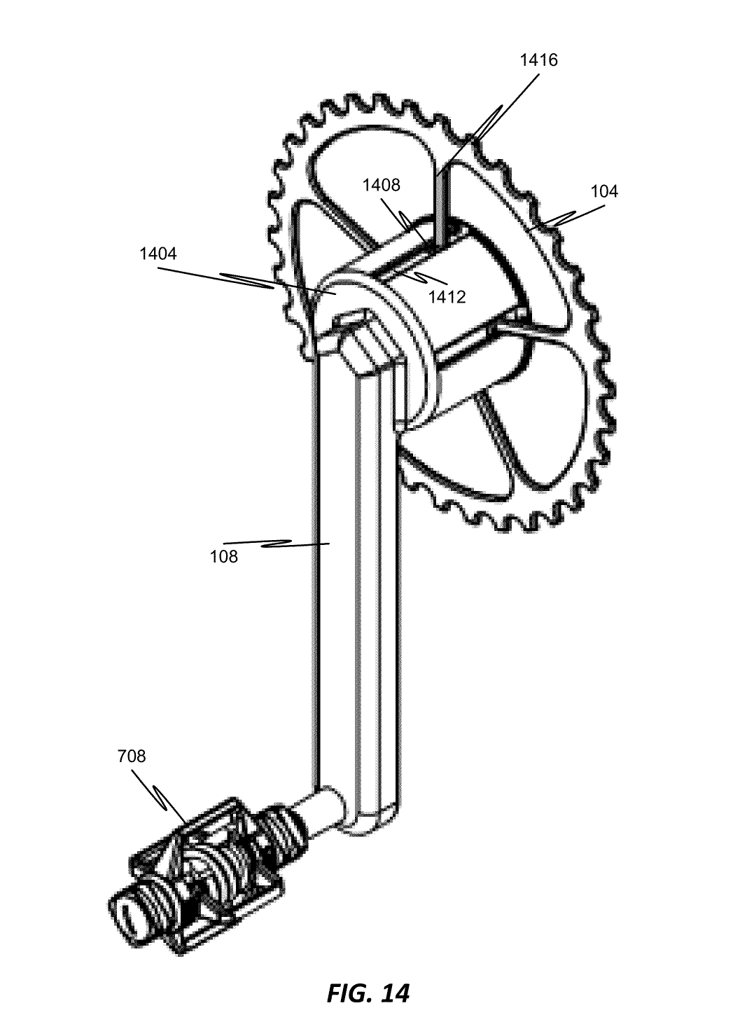

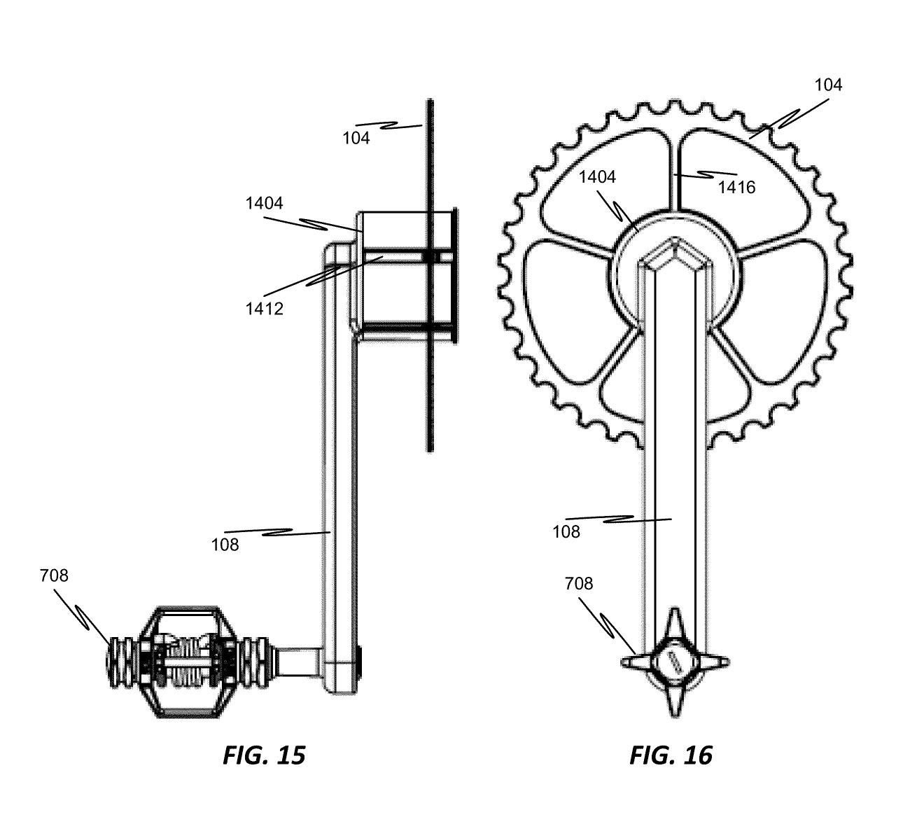

FIGS. 14-16 depict still another crankset 100 design with a different realization of float elements 116. In this particular design, the crankset 100 still comprises a main body 1404 with slots 1412, but the slots 1412 comprise a different configuration than the tracks 1112 of FIGS. 11-13. In particular, the slots 1412 may be configured to have radial elements 1416 of the sprockets 104 pass there through. A rolling or sliding portion 1408 may be provided at the ends of the radial elements 1416. The rolling or sliding portion 1408 may extend outwardly (e.g., have a thickness larger than the thickness of the radial elements 1416) and may move along the slots 1412. Even more specifically, the slots 1412 may comprise a t-shaped cross-section and bearing components of the rolling or sliding portion 1408 may be set underneath the outer surface of the main body 1404. By positioning the rolling or sliding portion 1408 inside the slot 1412, the bearings or moving components of the rolling or sliding portion 1408 are further protected from dirt, debris, and other particulates that could otherwise harm the operation of the rolling or sliding portion 1408. Furthermore, the bearings provided on the rolling or sliding portion 1408 or any other float element 116 described herein can be sealed or unsealed to further limit the amount of debris reaching the moving parts thereof

It should also be appreciated that bearings or wheels may be integrated into the main body 1404 rather than the portion of the sprocket 104. Accordingly, the sprocket 104 may comprise a substantially non-moving piece of material whereas the main body 1404 may comprise one or more moving pieces (e.g., bearings) that enable the free movement of the sprocket 104 along the length of the main body 1404.

Based on the discussions herein, it should be appreciated that any number of designs can be used to achieve the overall purpose of the float elements 116. Indeed, any type of track, rail, wheel, slide, post, notch, etc. can be used to enable the float elements 116 to operate as described. Embodiments of the present disclosure are not necessarily limited to the specific designs of the float elements 116 and cranksets 100 described herein.

While illustrative embodiments of the disclosure have been described in detail herein, it is to be understood that the inventive concepts may be otherwise variously embodied and employed, and that the appended claims are intended to be construed to include such variations, except as limited by the prior art.

1. A bicycle transmission system, comprising:
a crankset including a float element and at least one sprocket configured to rotate in a first rotational direction and further configured to move in a direction substantially perpendicular to the first rotational direction via the float element.

2. The system of claim 1, wherein the at least one sprocket is configured to move freely between a first position and a second position, the first position corresponding to a first lateral distance from a crank arm of the crankset, the second position corresponding to a second lateral distance from the crank arm, the second lateral distance being greater than the first lateral distance.

3. The system of claim 2, wherein the first lateral distance corresponds to a minimum displacement distance, wherein the second lateral distance corresponds to a maximum displacement distance, and wherein the at least one sprocket is allowed to move and rest at any position between the minimum displacement distance and the maximum displacement distance.

4. The system of claim 3, further comprising:
a chain having a plurality of chain joints, at least some of the chain joints being configured to interface with teeth of the at least one sprocket and wherein forces which angle the chain joints relative to one another are also capable of moving the at least one sprocket laterally along the float element.

5. The system of claim 4, further comprising:
a set of sprockets including an inner sprocket and an outer sprocket, wherein a selected one of the set of sprockets is connected to the at least one sprocket via the chain, wherein rotational forces exerted on the chain via the at least one sprocket cause the set of sprockets to rotate, wherein the float element is configured to automatically move to the first position when the selected sprocket is the inner sprocket, and wherein the float element is configured to automatically move to the second position when the selected sprocket is the outer sprocket.

6. The system of claim 1, wherein the float element comprises a shaft extending from a portion of a crank arm and a slider bracket configured to interface with the at least one sprocket such that when the slider bracket moves the at least one sprocket also moves, wherein the shaft comprises an outer surface and the slider bracket comprises an inner surface that interfaces with the outer surface of the shaft thereby enabling the slider bracket to move laterally along the outer surface of the shaft.

7. The system of claim 6, wherein the outer surface of the shaft is cylindrical and substantially smooth and wherein the inner surface of the slider bracket is also substantially smooth and comprises a radius that is larger than a radius of the outer surface of the shaft.

8. The system of claim 6, wherein the outer surface of the shaft comprises at least one of a recessed and raised feature that extends the length of the shaft and wherein the inner surface of the slider bracket comprises at least one complimentary feature that interfaces with the at least one of a recessed and raised feature of the outer surface of the shaft.

9. The system of claim 6, wherein the float element comprises a stopper that interfaces with the slider bracket when the at least one sprocket is at a maximum displacement position.

10. The system of claim 1, wherein the float element rides along at least one of a track, groove, rail, notch, and slot provided in a main body and wherein at least one of the float element and the main body comprise at least one ball bearing to facilitate lateral movement of the float element along the length of the main body.

11. The system of claim 10, wherein the at least one ball bearing is sealed.

12. The system of claim 1, wherein the float element integral to a crank arm of the crankset

13. The system of claim 1, wherein the at least one sprocket is a single sprocket.

14. A crankset for use with a transmission system, the crankset comprising:
a crank arm comprising a distal end and a proximate end being co-located with a rotational hub, the distal end being configured to rotate about the proximate end;
at least one float element operatively connected with the crank arm and also being configured to rotate about the proximate end; and
a sprocket configured to rotate about the proximate end as well as move laterally with respect to the crank arm via the at least one float element.

15. The crankset of claim 14, wherein the sprocket is configured to move laterally amongst an infinite number of lateral positions between a minimum displacement position and a maximum displacement position, wherein the sprocket is one of a plurality of sprockets.

16. (canceled)

17. The crankset of claim 14, wherein the at least one float element and the crank arm are a single unitary piece of material.

18. The crankset of claim 14, wherein the at least one float element comprises at least one bearing.

19. The crankset of claim 14, wherein the at least one float element comprises a shaft and slider bracket, the slider bracket being connectable to the sprocket and being configured to slide laterally along the shaft.

20. A method of operating a bicycle transmission system, comprising:
rotating a sprocket about a point of rotation;
receiving, at the sprocket from a chain, at least one force that is transverse to the rotation of the sprocket; and
in response to the at least one force, moving the sprocket in a direction that is substantially perpendicular to the rotation of the sprocket.

21. The method of claim 20, wherein the at least one force is received in response to changing gears of the bicycle, wherein the sprocket is moved from a first distance away from a crank arm to a second different distance away from the crank arm.

22. (canceled)
